(19) United States
(12) Patent Application Publication
(10) Pub. No.: US 2026/0145542 A1
(43) Pub. Date: May 28, 2026

(54) CONTROL DEVICE AND CONTROL METHOD

(71) Applicant: HONDA MOTOR CO., LTD., Tokyo (JP)

(72) Inventor: Kenichi FUKUDA, Tokyo (JP)

(73) Assignee: HONDA MOTOR CO., LTD., Tokyo (JP)

(21) Appl. No.: 19/177,634

(22) Filed: Apr. 14, 2025

(30) Foreign Application Priority Data
Apr. 24, 2024 (JP) 2024-070419

(51) Int. Cl. B60L 7/18; B60L 7/26; B60L 58/25

(52) U.S. Cl. CPC B60L 7/18; B60L 7/26; B60L 58/25; B60L 2240/545; B60L 2240/549

(57) ABSTRACT

A control device that controls a vehicle including a drive wheel, a motor-generator that performs regeneration by braking the drive wheel and a battery supplied with regenerative electric power generated by the regeneration, includes: a calculation unit that calculates a current value under which a heat absorption amount of the battery is equal to or greater than a heat generation amount during the regeneration, based on a resistance value of the battery and a reaction heat per unit current value generated by an electrochemical reaction of the battery; and a control unit that controls the motor-generator based on the calculated current value.

This application is based upon and claims the benefit of priority from prior Japanese patent application No. 2024-70419, filed on Apr. 24, 2024, the entire contents of which are incorporated herein by reference.

### TECHNICAL FIELD

The present disclosure relates to a control device, and a control method.

### BACKGROUND ART

In recent years, efforts to realize a low-carbon society or a decarbonized society become active, and research and development about an electrification technique are conducted to reduce CO₂ emission and improve energy efficiency in vehicles.

For example, JP5724704B describes a regeneration control device configured to calculate a regenerative current flowing through a battery from a map based on a battery voltage when a temperature of the battery is less than a threshold, and calculate the regenerative current flowing through the battery from a map based on a charging rate of the battery when the temperature of the battery is equal to or greater than the threshold.

### SUMMARY OF INVENTION

However, in the related art, there is room for improvement in terms of increasing a regeneration amount while preventing an increase in the temperature of the battery.

Aspects of the present disclosure relate to providing a control device and a control method capable of increasing a regeneration amount while preventing an increase in a temperature of a battery.

According to an aspect of the present disclosure, there is provided a control device that controls a vehicle including a drive wheel, a motor-generator that performs regeneration by braking the drive wheel and a battery supplied with regenerative electric power generated by the regeneration, the control device including:
a calculation unit that calculates a current value under which a heat absorption amount of the battery is equal to or greater than a heat generation amount during the regeneration, based on a resistance value of the battery and a reaction heat per unit current value generated by an electrochemical reaction of the battery; and a control unit that controls the motor-generator based on the calculated current value.

According to another aspect of the present disclosure, there is provided a control method performed by a computer that controls a vehicle including a drive wheel, a motor-generator that performs regeneration by braking the drive wheel and a battery supplied with regenerative electric power generated by the regeneration, the control method including:
calculating a current value under which a heat absorption amount of the battery is equal to or greater than a heat generation amount during the regeneration, based on a resistance value of the battery and a reaction heat per unit current value generated by an electrochemical reaction of the battery, and
controlling the motor-generator based on the calculated current value.

According to aspects of the present disclosure, it is possible to increase the regeneration amount while preventing an increase in the temperature of the battery, thereby contributing to improvement of energy efficiency.

### BRIEF DESCRIPTION OF DRAWINGS

Exemplary embodiment(s) of the present invention will be described in detail based on the following figures, wherein

FIG. 1 is a scheme diagram illustrating a configuration of a vehicle Ve equipped with a control device 20 according to the present embodiment;

FIG. 2 illustrates an example of a heat generation characteristic during regeneration;

FIG. 3 is a block diagram illustrating an example of the control device 20;

FIG. 4 illustrates an example of a map for deriving a resistance value R;

FIG. 5 illustrates an example of a map for deriving a reaction heat S per unit current value;

FIG. 6 illustrates an example of a map for setting a temperature increase prevention coefficient K;

FIG. 7 is a flowchart illustrating an example of processing executed by the control device 20 of the present embodiment; and

FIG. 8 is a diagram illustrating an example of a change in battery temperature during discharging and during regeneration in the present embodiment.

### DESCRIPTION OF EMBODIMENTS

Hereinafter, an embodiment of the present disclosure will be described with reference to the accompanying drawings. The following embodiment does not limit the present disclosure, and not all of elements described in the following embodiment are necessary to the present disclosure. Further, two or more elements described in the following embodiment may be freely combined without departing from the gist of the present disclosure. Hereinafter, the same or similar elements are denoted by the same or similar reference signs, and a description thereof may be omitted or simplified.

The control device 20 in the present embodiment is mounted on a vehicle Ve, and the control device 20 performs control related to regeneration of a motor having an electric power generation function.

### (Vehicle)

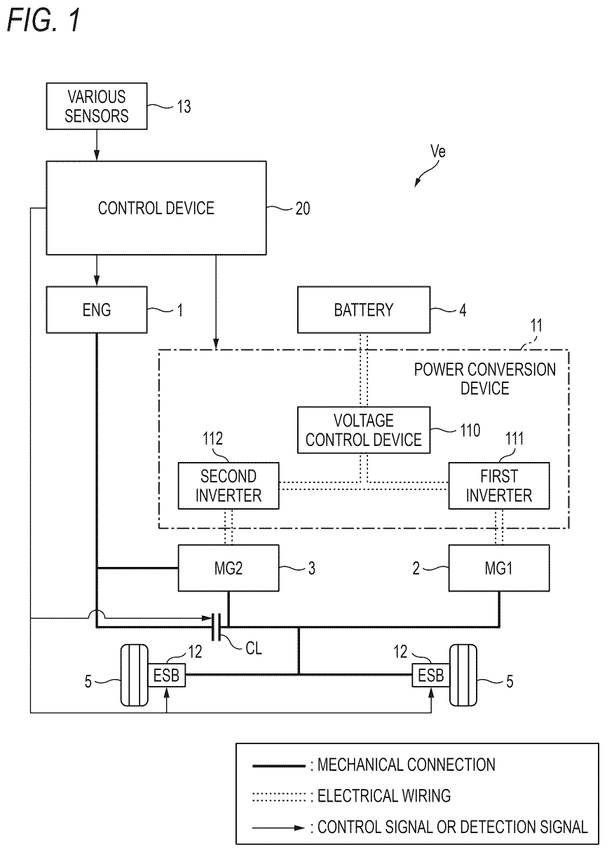

First, the vehicle Ve on which the control device 20 is mounted will be described. The vehicle Ve may be, for example, a vehicle including a motor having an electric power generation function. Therefore, the vehicle Ve may be, for example, a hybrid vehicle including an engine and a motor as drive sources, or an electric automobile including only a motor as a drive source. In the present embodiment, as illustrated in FIG. 1, a hybrid vehicle will be described as an example. The vehicle Ve includes an engine (ENG) 1 that is an example of an internal combustion engine, a first motor-generator (MG1) 2 that is an example of an electric motor, a second motor-generator (MG) 3 that is an example of an electric generator, a battery 4 that is an example of a power storage device, a clutch CL, a power conversion device 11, a brake device 12, various sensors 13, and the control device 20 that controls the vehicle. Note that in FIG. 1, thick solid lines indicate mechanical connections, double dashed lines indicate electrical wiring, and thin solid arrows indicate transmission and reception of control signals or detection signals.

The engine 1 is, for example, a gasoline engine or a diesel engine, and outputs power generated by burning supplied fuel. The engine 1 is coupled to the second motor-generator 3 and is coupled to drive wheels 5 of the vehicle Ve via the clutch CL. The power output from the engine 1 is transmitted to the second motor-generator 3 when the clutch CL is in a disengaged state, and is transmitted to the second motor-generator 3 and the drive wheels 5 when the clutch CL is in a connected state (engaged state).

The first motor-generator 2 is a motor-generator (so-called “traction motor”) mainly used as a drive source of the vehicle Ve, and is implemented by, for example, an AC motor. The first motor-generator 2 is electrically connected to the battery 4 and the second motor-generator 3 via the power conversion device 11. The first motor-generator 2 can be supplied with electric power from at least one of the battery 4 and the second motor-generator 3. When supplied with the electric power, the first motor-generator 2 operates as an electric motor and outputs power for the vehicle Ve to travel. The first motor-generator 2 is coupled to the drive wheels 5, and the power output from the first motor-generator 2 is transmitted to the drive wheels 5. The vehicle Ve travels by at least one of the output of the engine 1 or the output of the first motor-generator 2 being transmitted to the drive wheels 5.

When the vehicle Ve is braked (when rotated by the engine 1 or the drive wheels 5), the first motor-generator 2 performs a regeneration operation as an electric generator to generate electric power (so-called regenerative electric power generation). The electric power generated by the regeneration of the first motor-generator 2 (hereinafter, also referred to as “regenerative electric power”) is supplied to the battery 4 via the power conversion device 11, for example. In this way, the battery 4 can be charged with the regenerative electric power.

The regenerative electric power may be not supplied to the battery 4 but supplied to the second motor-generator 3 via the power conversion device 11. By supplying the regenerative electric power to the second motor-generator 3, it is possible to perform “power waste” of consuming the regenerative electric power without charging the battery 4. Note that during power waste, the regenerative electric power supplied to the second motor-generator 3 is used for driving the second motor-generator 3, and power generated thereby is input to the engine 1 and thus is consumed by the mechanical friction loss of the engine 1 and the like.

The second motor-generator 3 is a motor-generator mainly used as an electric generator, and is implemented by, for example, an AC motor. The second motor-generator 3 is driven by the power of the engine 1 to generate electric power. The electric power generated by the second motor-generator 3 is supplied to at least one of the battery 4 or the first motor-generator 2 via the power conversion device 11. By supplying the electric power generated by the second motor-generator 3 to the battery 4, the battery 4 can be charged with the electric power. By supplying the electric power generated by the second motor-generator 3 to the first motor-generator 2, the first motor-generator 2 can be driven by the electric power.

The power conversion device 11 is a device for converting input electric power and outputting the converted electric power (also referred to as a so-called “power control unit” (PCU)), and is connected to the first motor-generator 2, the second motor-generator 3, and the battery 4. For example, the power conversion device 11 includes a first inverter 111, a second inverter 112, and a voltage control device 110. The first inverter 111, the second inverter 112, and the voltage control device 110 are electrically connected to each other.

The voltage control device 110 converts an input voltage and outputs the converted voltage. The voltage control device 110 may be a DC/DC converter or the like. For example, when supplying the electric power of the battery 4 to the first motor-generator 2, the voltage control device 110 boosts an output voltage of the battery 4 and outputs the boosted voltage to the first inverter 111. For example, when the first motor-generator 2 performs regenerative electric power generation, the voltage control device 110 steps down an output voltage of the first motor-generator 2 received via the first inverter 111 and outputs the stepped down voltage to the battery 4. When the second motor-generator 3 generates electric power, the voltage control device 110 steps down than output voltage of the second motor-generator 3 received via the second inverter 112 and outputs the stepped down voltage to the battery 4.

When the electric power of the battery 4 is supplied to the first motor-generator 2, the first inverter 111 converts the electric power (direct current) of the battery 4 received via the voltage control device 110 into an alternating current and outputs the alternating current to the first motor-generator 2. When the first motor-generator 2 performs regenerative electric power generation, the first inverter 111 converts the electric power (alternating current) received from the first motor-generator 2 to a direct current and outputs the direct current to the voltage control device 110. When the regenerative electric power of the first motor-generator 2 is to be wasted, the first inverter 111 converts the electric power (alternating current) received from the first motor-generator 2 to a direct current and outputs the direct current to the second inverter 112.

When the second motor-generator 3 generates electric power, the second inverter 112 converts the electric power (alternating current) received from the second motor-generator 3 to a direct current and outputs the direct current to the voltage control device 110. When the regenerative electric power of the first motor-generator 2 is to be wasted, the second inverter 112 converts the regenerative electric power (direct current) of the first motor-generator 2 received via the first inverter 111 into an alternating current and outputs the alternating current to the second motor-generator 3.

The battery 4 is a chargeable and dischargeable secondary battery, and includes a plurality of power storage cells connected in series or series-parallel. The battery 4 is configured to output a high voltage of, for example, 100 [V] to 400 [V]. A lithium-ion battery, a nickel-metal hydride battery, or the like may be used as the storage cell of the battery 4. Note that an upper limit temperature of the battery 4 is set to, for example, about 40[° C.] in consideration of durability of the battery 4.

The clutch CL can be set to a connected state in which a power transmission path from the engine 1 to the drive wheels 5 is connected (engaged), and can be set to a disengaged state in which the power transmission path from the engine 1 to the drive wheels 5 is disengaged (cut off). The output of the engine 1 is transmitted to the drive wheels 5 when the clutch CL is in the connected state, and is not transmitted to the drive wheels 5 when the clutch CL is in the disengaged state.

The brake device 12 is an example of a “brake device” of the present disclosure, and the brake device 12 is used in a brake-by-wire system that brakes the vehicle Ve. The brake-by-wire system is a system in which the brake device 12 brakes the vehicle Ve under the control of the control device 20, in which a brake pedal (not illustrated) and each member constituting the brake device 12 are not mechanically connected, and the brake device 12 is controlled to brake the vehicle Ve based on an output signal of a brake position sensor which is one of the various sensors 13. Note that the brake device 12 is implemented by, for example, an electric servo brake device (ESB) including a brake caliper, a cylinder that transmits a hydraulic pressure to the brake caliper, and an electric motor that causes the cylinder to generate the hydraulic pressure (all not illustrated). The electric servo brake device brakes the vehicle Ve by a hydraulic pressure controlled according to an operation on the brake pedal by a driver. The electric servo brake device controls the electric motor according to an input operation amount on the brake pedal, and outputs a braking torque corresponding to the braking operation to each wheel.

Note that the brake device 12 is not limited to the electric servo brake device, and may be an electronically controlled hydraulic brake device. The electronically controlled hydraulic brake device controls an actuator according to an input operation amount on the brake pedal to transmit a hydraulic pressure of a master cylinder to the cylinder. In the present embodiment, as described above, since a regenerative braking force can be generated by the first motor-generator 2, the control device 20 generates a desired braking force by controlling the regenerative braking force and a mechanical braking force generated by the brake device 12 in coordination with each other with respect to a required braking force based on the operation on the brake pedal.

The various sensors 13 include, for example, a vehicle speed sensor that detects a travel speed (vehicle speed) of the vehicle Ve, an accelerator position sensor that detects an operation amount on an accelerator pedal of the vehicle Ve, the brake position sensor that detects the operation amount on the brake pedal of the vehicle Ve, and a battery sensor that detects various information on the battery 4 (for example, a voltage value of the battery 4, a current value in charging and discharging or regeneration, and a temperature of the battery). Detection results from the various sensors 13 are transmitted to the control device 20 as detection signals.

The control device 20 is a computer that includes, for example, a processor for performing various calculations, a storage unit including a non-transitory storage medium for storing various kinds of information (for example, each map and program described later), and an input and output unit that controls input and output of data between inside and outside of the control device 20 (all not illustrated), and that controls the entire vehicle Ve. For example, the control device 20 is implemented by one electronic control unit (ECU) or by a plurality of ECUs working in cooperation with each other.

Specifically, the control device 20 is provided to be able to communicate with the engine 1, the clutch CL, the power conversion device 11, the brake device 12, and the various sensors 13. The control device 20 controls the outputs of the first motor-generator 2 and the second motor-generator 3 by controlling the output of the engine 1 and controlling the power conversion device 11. The control device 20 controls the first motor-generator 2 and the brake device 12 to control a braking force of the vehicle Ve.

Note that the control device 20 can control a travel mode of the vehicle Ve by controlling the output of the engine 1, controlling the output of each of the motor-generators 2 and 3, and controlling the clutch CL. The travel modes of the vehicle Ve include, for example, an “engine travel mode” in which the vehicle Ve travels mainly by the power output from the engine 1, a “hybrid travel mode” in which at least the electric power generated by the second motor-generator 3 is supplied to the first motor-generator 2 and the vehicle Ve travels mainly by the power output from the first motor-generator 2 according to the electric power, and an “EV travel mode” in which only the electric power of the battery 4 is supplied to the first motor-generator 2 and the vehicle Ve travels by the power output from the first motor-generator 2 according to the electric power.

The control device 20 executes, for example, various programs stored in the storage unit. In regeneration control of a battery in the related art (for example, JP5724704B), when a temperature of the battery (hereinafter, also referred to as a “battery temperature”) increases to a predetermined temperature, a regenerative current is reduced to prevent an increase in the battery temperature. On the other hand, a chemical reaction (electrochemical reaction) occurring when a regenerative current (or a charging current) flows through the battery does not necessarily increase the battery temperature. Specifically, in a lithium ion battery used as the battery, a reaction heat is generated by an electrochemical reaction during charging and discharging. Regarding the reaction heat, generally, heat is generated during discharging and heat is absorbed during charging. Regarding an endothermic reaction during charging, a heat generation amount Q generated by the entire battery during charging of the battery 4 can be expressed by a heat absorption amount Qs due to the endothermic reaction and a heat generation amount Qr generated when the charging current passes through the battery 4 (that is, Joule heat, which is a loss due to current flow), as given by the following formula (1).

$$Q = Q s + Q r \qquad ( 1 )$$

Here, assuming that the heat generation that causes the battery temperature to increase is “positive” and the heat absorption that causes the temperature of the battery to decrease is “negative”, it can be said that the entire battery is in a heat generation state when a value of the above formula (1) is “positive” and the entire battery is in a heat absorption state when the value of the formula (1) is “negative”. Note that when the value of the formula (1) is “0” since the heat absorption amount Qs and the heat generation amount Qr are the same value, the battery temperature is in an equilibrium state of not increasing.

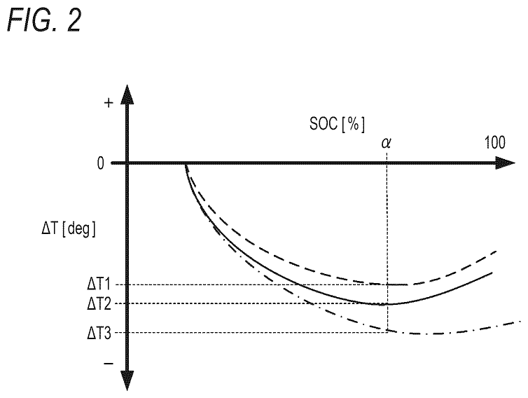

FIG. 2 is a diagram illustrating an example of a heat generation characteristic during charging, in which a horizontal axis represents a state of charge (SOC) indicating a remaining charge amount (charging rate) of the battery, and a vertical axis represents ΔT indicating a temperature change in the battery 4. In the example illustrated in FIG. 2, examples of cases where the battery 4 is charged at charging speeds (in other words, charging currents) of three patterns (a solid line, a broken line, and a one-dot chain line) are illustrated, and in these cases, the temperatures of the battery 4 decrease to ΔT1, ΔT2, and ΔT3, respectively, in a process in which the SOC increases from a low state to “α”. That is, it can be understood that the battery temperature may decrease when the battery 4 is charged with the electric power generated by regenerative electric power generation.

Note that although the examples illustrated in FIG. 2 are events occurring during charging of the battery 4, it can be assumed that such events similarly occur during regeneration. In the present embodiment, it is assumed that all the regenerated electric power is stored in the battery 4. Therefore, in the following description, unless otherwise specified, it is assumed that the current in regeneration (regenerative current) and the current in charging (charging current) are similar to each other.

In the present embodiment, during such regeneration, the regeneration control is performed focusing on that the battery temperature does not increase or the temperature of the battery decreases.

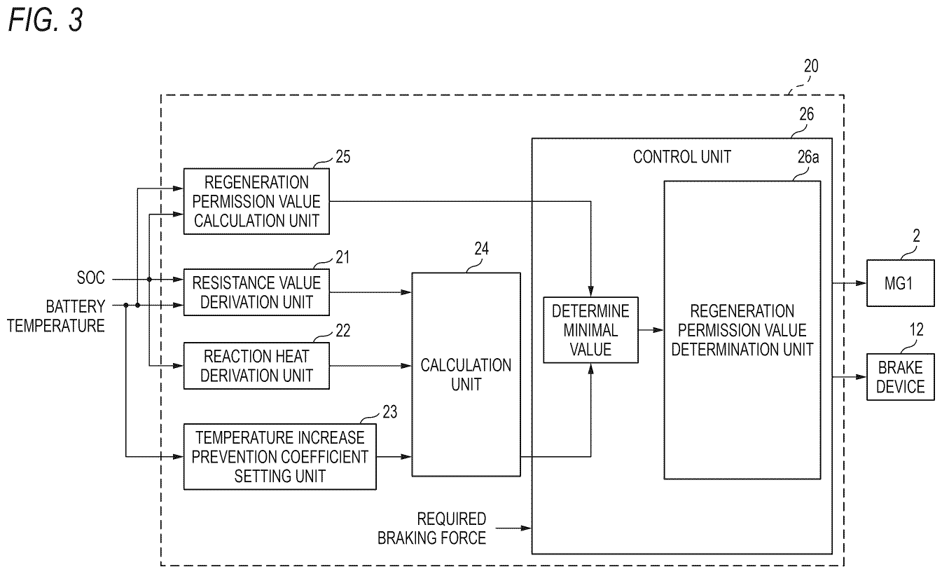

Specifically, as an example of the program recorded in the storage unit, the control device 20 executes a program for regeneration control processing of calculating a current value under which the heat absorption amount Qs of the battery is equal to or greater than the heat generation amount Qr during regeneration to perform regeneration control. As illustrated in FIG. 3, the control device 20 includes a resistance value derivation unit 21, a reaction heat derivation unit 22, a temperature increase prevention coefficient setting unit 23, a calculation unit 24, a regeneration permission value calculation unit 25, and a control unit 26 as functional units implemented by executing the program. Note that in the following description, processing performed by the resistance value derivation unit 21, the reaction heat derivation unit 22, the temperature increase prevention coefficient setting unit 23, the calculation unit 24, the regeneration permission value calculation unit 25, and the control unit 26 are processing implemented by the control device 20.

The resistance value derivation unit 21 derives a resistance value R of the battery 4. Here, the resistance value R is an estimated value of an internal resistance of the battery 4. Specifically, the resistance value derivation unit 21 acquires a current remaining charge amount (hereinafter, also referred to as “SOC”) of the battery 4 based on a detection value of the battery sensor, which is one of the various sensors 13. Then, the resistance value derivation unit 21 derives the resistance value R of the battery 4 based on the current SOC of the battery 4 with reference to a map in which the acquired current SOC of the battery 4 and the resistance value R under the SOC are associated with each other.

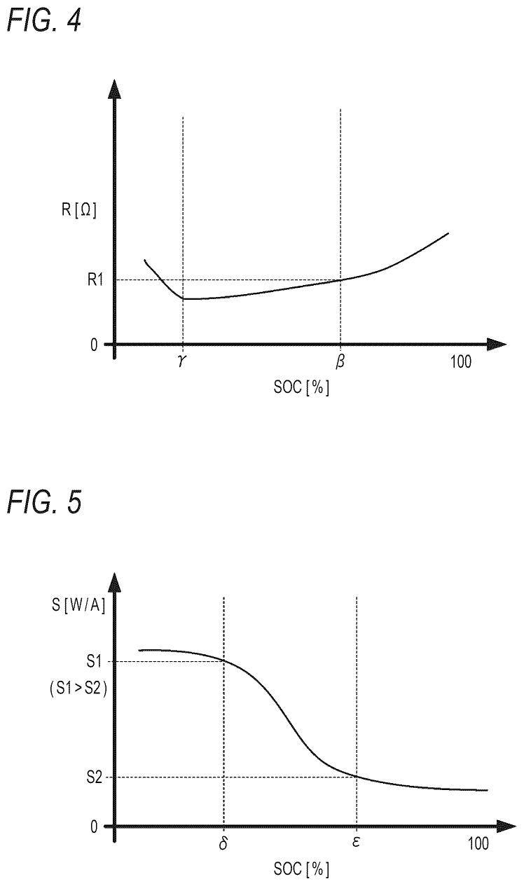

FIG. 4 is an example of the map for deriving the resistance value R of the battery 4 during regeneration (during charging), in which a horizontal axis represents the SOC and a vertical axis represents a resistance value R. The resistance value derivation unit 21 derives the resistance value R as “R1 [Ω]” when the SOC is “β[%]”, for example, with reference to the map of FIG. 4. Note that it can be understood from the map of FIG. 4 that, for example, the resistance value R is equal to or less than “R1 [Ω]” in a region where the SOC is between “γ[%]” (where γ<β)” and “β[%]”, which is relatively low, and the resistance value R is lower than when the SOC is equal to or more than “β [Ω]”, which is relatively high. Note that the map illustrated in FIG. 4 indicates the resistance value R (for example, an average value) when the temperature of the battery 4 is in a predetermined temperature range (for example, 20[° C.] to 35[° C.]).

On the other hand, the resistance value derivation unit 21 may derive the resistance value R of the battery 4 based on each battery temperature. The resistance value R of the battery 4 may change according to the battery temperature. Therefore, the resistance value derivation unit 21 may predetermine a map such as that illustrated in FIG. 4 for each battery temperature (for example, at an interval of 5[° C.], such as for 5[° C.], 10[° C.], 15[° C.], . . . and 40[° C.]), and derive the resistance value R of the battery 4 by referring to the map.

The reaction heat derivation unit 22 derives reaction heat S per unit current value (hereinafter, also referred to as “reaction heat S per unit current value”) generated by the electrochemical reaction of the battery 4. Specifically, the reaction heat derivation unit 22 acquires the current SOC of the battery 4 based on the detection value of the battery sensor, which is one of the various sensors 13, and derives the reaction heat S per unit current value based on the acquired SOC. In the present embodiment, the reaction heat derivation unit 22 derives the resistance value R of the battery 4 based on the current SOC of the battery 4 with reference to a map in which the acquired current SOC of the battery 4 and the reaction heat S per unit current value under the current SOC are associated with each other.

FIG. 5 is an example of a map for deriving the reaction heat S per unit current value during regeneration (during charging), in which a horizontal axis represents the SOC and a vertical axis represents the reaction heat S per unit current value. With reference to the map of FIG. 5, for example, when the SOC is “δ[%]”, the reaction heat derivation unit 22 derives the reaction heat S per unit current value as “S1 [W/A]”. On the other hand, for example, when the SOC is “ε[%]” (where ε>δ), the reaction heat derivation unit 22 derives the reaction heat S per unit current value as “S2 [W/A]”. As can be understood from FIG. 5, the reaction heat S per unit current value decreases as the SOC increases, and for example, in a region where the SOC is between “δ[%]” and “ε[%]”, the reaction heat S per unit current value decreases greatly as compared with in other regions. Note that, in the region between “δ[%]” and “ε[%]”, the reaction heat S per unit current value decreases greatly and gradually but not locally. The map illustrated in FIG. 5 indicates the reaction heat S (for example, an average value) per unit current value when the temperature of the battery 4 is in a predetermined temperature range (for example, 20[° C.] to 35[° C.]).

On the other hand, the reaction heat derivation unit 22 may derive the reaction heat S per unit current value based on the battery temperature. The reaction heat S per unit current value may change depending on the battery temperature. Therefore, the reaction heat derivation unit 22 may predetermine a map such as that illustrated in FIG. 5 for each battery temperature (for example, at an interval of 5[° C.], such as for 5[° C.], 10[° C.], 15[° C.], . . . and 40[° C.]), and derive the reaction heat S per unit current value by referring to the map.

The temperature increase prevention coefficient setting unit 23 sets a temperature increase prevention coefficient K for correcting, according to the battery temperature, a current value under which the heat absorption amount Qs calculated by the calculation unit 24 described later is equal to or greater than the heat generation amount Qr. When the current battery temperature is equal to or higher than a predetermined temperature (for example, 35[° C.]) near an upper limit temperature (for example, 40[° C.]), it is preferable to limit the current value so that the battery temperature does not increase to the predetermined temperature or higher. Therefore, the temperature increase prevention coefficient setting unit 23 sets the temperature increase prevention coefficient K, which is a predetermined correction coefficient corresponding to the battery temperature.

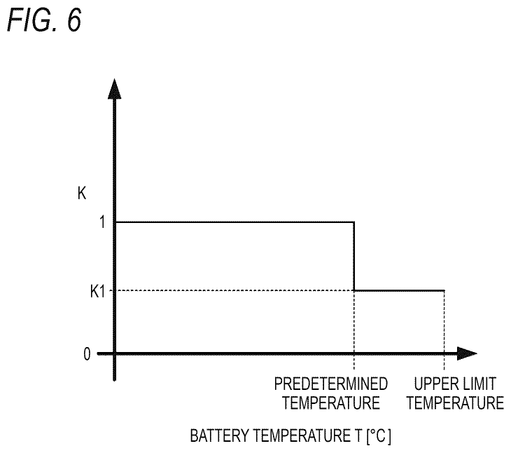

FIG. 6 is an example of a map in which the temperature increase prevention coefficient K is associated with the battery temperature, in which a horizontal axis represents the battery temperature and a vertical axis represents the temperature increase prevention coefficient K. The temperature increase prevention coefficient setting unit 23 sets the temperature increase prevention coefficient K with reference to the map of FIG. 6, for example. Note that as can be understood from FIG. 6, when the battery temperature is lower than a predetermined temperature, the temperature increase prevention coefficient K is set to “1”, and when the battery temperature is equal to or higher than the predetermined temperature, the temperature increase prevention coefficient K is set to “K1” smaller than 1.

The calculation unit 24 calculates a current value under which the heat absorption amount Qs of the battery 4 during regeneration is equal to or greater than the heat generation amount Qr during regeneration. That is, the calculation unit 24 calculates a current value under which the battery temperature does not increase or decreases since the heat absorption amount becomes equal to or greater than the heat generation amount. Specifically, a current value under which the heat absorption amount Qs of the battery 4 is equal to or greater than the heat generation amount Qr during regeneration is calculated based on the resistance value R of the battery 4 derived by the function of the resistance value derivation unit 21 and the reaction heat S per unit current value of the battery 4 derived by the function of the reaction heat derivation unit 22. As described above, the heat generation amount Q of the entire battery 4 during regeneration satisfies the relation (Q=Qr+Qs) expressed by the formula (1) according to a relation between the heat generation amount Qr and the heat absorption amount Qs when energized. When it is estimated that the battery temperature does not increase when the heat absorption amount Qs is equal to or greater than the heat generation amount Qr, and energization of the battery 4 is permitted, an inequality expressed by the following formula (2) is satisfied.

$$Q r \leq Q s \qquad ( 2 )$$

The heat generation amount Qr can be expressed by the following formula (3) using the resistance value R of the battery 4, the reaction heat S per unit current value, and a current value I. Similarly, the heat absorption amount Qs can be expressed by the following formula (4).

$$Q r = R \times {I}^{2} \qquad ( 3 )$$

$$Qs = S \times I \qquad ( 4 )$$

When the above formulae (3) and (4) are substituted into the formula (2) to calculate the current value “I” under which the heat absorption amount Qs of the battery 4 is equal to or greater than the heat generation amount Qr during regeneration, a relation expressed by the following formula (5) is satisfied.

$$I \leq S / R \qquad ( 5 )$$

That is, when the above formula (5) is satisfied, the entire battery absorbs heat, and the battery temperature does not increase or the battery temperature decreases. In this way, the calculation unit 24 calculates the current value under which the heat absorption amount Qs of the battery 4 during regeneration is equal to or greater than the heat generation amount Qr during regeneration.

When the current battery temperature is equal to or higher than the predetermined temperature near the upper limit temperature, the calculation unit 24 corrects the current value by multiplying, by the above-described temperature increase prevention coefficient K, the current value under which the heat absorption amount of the battery 4 is equal to or greater than the heat generation amount during regeneration. That is, the calculation unit 24 multiplies the current value obtained by the formula (5) described above by the temperature increase prevention coefficient K set by the temperature increase prevention coefficient setting unit 23 described above.

The regeneration permission value calculation unit 25 calculates a current value under which the regeneration by the first motor-generator 2 is permitted according to a current state of the battery 4. The electric power that can be stored in the battery 4 may change according to the state of the SOC and the state of the battery temperature. Therefore, the regeneration permission value calculation unit 25 acquires the battery temperature and the SOC based on the detection value of the battery sensor. For example, in a case where the SOC of the battery 4 is low (for example, less than 80[%]) and the temperature thereof is an ideal temperature (for example, 15[° C.] to 35[° C.]) in consideration of durability and output of the battery 4, there is almost no limitation on storing electric power in the battery 4. Therefore, in this case, regeneration limitation is not applied. On the other hand, when the SOC is equal to or higher than 80[%] and is close to full charge, a regeneration amount is limited since a capacity of the battery is smaller than that in the full charge state. That is, the regeneration limitation is applied. Similarly, when the battery temperature is low, for example, 5[° C.], the resistance value of the battery 4 increases, and thus the regeneration limit is applied. In this way, the regeneration limitation may be applied according to the state of the battery 4. Therefore, the current value under which the regeneration is permitted obtained in this way may be different from the current value calculated by the calculation unit 24 described above. That is, the above-described calculation unit 24 calculates the current value possible for regeneration from the viewpoint of heat generation and heat absorption during regeneration, whereas the regeneration permission value calculation unit 25 calculates the current value possible for regeneration from the viewpoint of the SOC and the battery temperature.

The control unit 26 controls the first motor-generator 2 based on the calculated current value in regeneration. Specifically, the control unit 26 includes a regeneration permission value determination unit 26a that determines a current value to be regenerated. The regeneration permission value determination unit 26a determines a smaller value (minimal value) between the current value under which the heat absorption amount Qs is equal to or greater than the heat generation amount Qr calculated by the function of the above-described calculation unit 24 and the current value calculated by the regeneration permission value calculation unit 25 as the current value that can be actually regenerated.

The control unit 26 obtains the regenerative braking force from the current value possible for regeneration determined by the regeneration permission value determination unit 26a, and distributes each braking force so that the required braking force is output by the regenerative braking force and the mechanical braking force generated by the brake device 12. That is, the control unit 26 brakes the vehicle Ve by the regenerative braking force generated by the first motor-generator 2 and causing the brake device 12 to output the remaining braking force with respect to the required braking force. Then, the control unit 26 controls the current value generated by the regeneration in the first motor-generator 2 to generate the regenerative braking force based on the distributed result, and controls the hydraulic pressure and the like of the brake device 12 to generate the mechanical braking force based on the distributed result.

### (Processing Executed by Control Device)

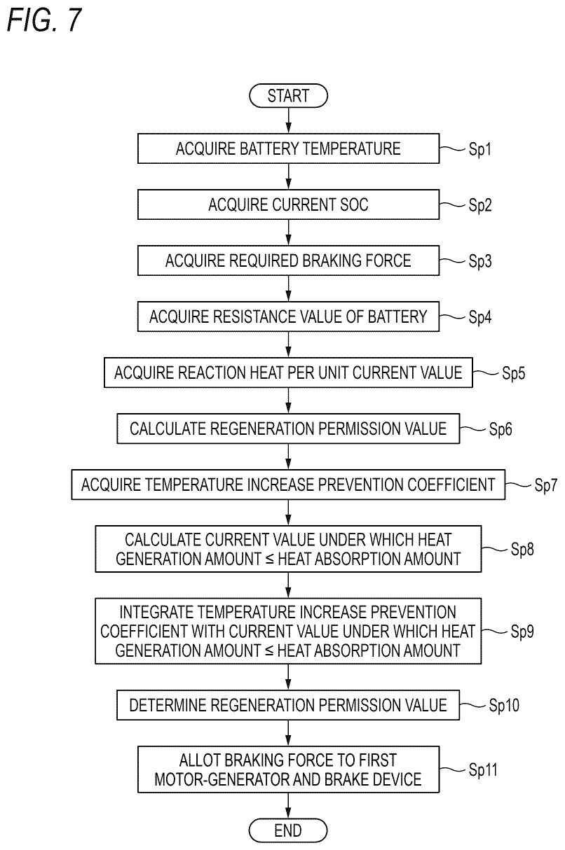

Next, an example of the regeneration control processing executed by the control device 20 will be described with reference to a flowchart. FIG. 7 is a flowchart illustrating an example of the processing, and the processing is executed, for example, when the vehicle Ve is traveling (in particular, when a braking request for the vehicle Ve is made by the driver).

The control device 20 first acquires the battery temperature (step Sp1). That is, the control device 20 acquires the battery temperature detected by the battery sensor, which is one of the various sensors 13.

Next, the control device 20 acquires the current SOC of the battery 4 (step Sp2). Specifically, the control device 20 acquires the SOC of the battery 4 by estimating the SOC of the battery 4 based on the voltage of the battery 4 detected by the battery sensor, for example.

Next, the control device 20 acquires the required braking force (step Sp3).

Specifically, the control device 20 acquires the required braking force based on, for example, a detection value of the brake position sensor and a vehicle speed V. Note that an order of the processing from step Sp1 to step Sp3 described above may be random.

Next, the control device 20 acquires the resistance value R of the battery 4 (step Sp4). That is, as described above with reference to FIG. 4 for example, by the function of the resistance value derivation unit 21, the control device 20 derives the resistance value R of the battery 4 based on the current SOC of the battery 4 with reference to the map in which the SOC of the battery 4 and the resistance value R under the SOC are associated with each other.

Next, the control device 20 acquires the reaction heat S per unit current value of the battery 4 (step Sp5). That is, as described above with reference to FIG. 5 for example, by the function of the reaction heat derivation unit 22, the control device 20 derives the resistance value R of the battery 4 based on the current SOC of the battery 4 with reference to the map in which the current SOC of the battery 4 and the reaction heat S per unit current value under the SOC are associated with each other.

Next, the control device 20 calculates a regeneration permission value of the battery 4 (step Sp6). That is, by the function of the regeneration permission value calculation unit 25, the control device 20 calculates, from the current SOC or the battery temperature of the battery 4, a current value under which the regeneration by the first motor-generator 2 is permitted.

Next, the control device 20 acquires the temperature increase prevention coefficient that is a correction coefficient for preventing an increase in the temperature of the battery 4 (Step Sp7). That is, as described with reference to FIG. 6 for example, by the function of the temperature increase prevention coefficient setting unit 23, the control device 20 acquires the temperature increase prevention coefficient K corresponding to the current battery temperature with reference to the map in which the battery temperature and the temperature increase prevention coefficient K are associated with each other. Note that an order of the processing from step Sp4 to step Sp7 described above may be random. Since the temperature increase prevention coefficient K is a value that can be set to a value smaller than a default value “1” when the battery temperature is equal to or higher than a predetermined temperature as described above, for example, when the battery temperature acquired in step Sp1 is lower than the predetermined temperature, step Sp7 may be skipped.

Next, the control device 20 calculates a current value under which the heat absorption amount Qs of the battery 4 is equal to or greater than the heat generation amount Qr during regeneration (Step Sp8). That is, by the function of the calculation unit 24, the control device 20 calculates a current value under which the heat absorption amount Qs is equal to or greater than the heat generation amount Qr based on the resistance value R of the battery 4 acquired in Step Sp4 and the reaction heat S per unit current value of the battery 4 acquired in Step Sp5.

Next, the control device 20 multiplies the current value calculated in step Sp8 by the temperature increase prevention coefficient K (step Sp9). Note that as described above, when the battery temperature acquired in step Sp1 is lower than the predetermined temperature, step Sp9 may be skipped since the temperature increase prevention coefficient K is “1”.

Next, the control device 20 determines the regeneration permission value (step Sp10). That is, by the function of the regeneration permission value determination unit 26a, the control device 20 compares the current value based on the regeneration permission value corresponding to the state of the battery 4 calculated in step Sp6 with the current value under which the heat absorption amount Qs is equal to or greater than the heat generation amount Qr calculated in step Sp9 (or step Sp8), and determines the smaller current value as the regeneration permission value. That is, the control device 20 sets, as the regeneration permission value, a current value under which the heat absorption amount Qs is equal to or greater than the heat generation amount Qr in the range of the regeneration permission value calculated in Step Sp6.

Then, the control device 20 distributes the braking force to the first motor-generator 2 and the brake device 12 based on a current value corresponding to the regeneration permission value determined in step Sp10 (step Sp11). That is, by the function of the control unit 26, the control device 20 distributes the required braking force to the regenerative braking force and the mechanical braking force generated by the brake device 12 so that the required braking force acquired in step Sp3 can be output by the regenerative braking force and the mechanical braking force. That is, the control device 20 causes the brake device 12 to generate a remaining braking force with respect to a required braking force left by the regeneration of the first motor-generator 2. Then, the control unit 26 controls the current value by the regeneration of the first motor-generator 2 based on the distributed result, and controls the hydraulic pressure and the like of the brake device 12 to generate the mechanical braking force. When the processing of step Sp11 is completed, the control device 20 ends the processing in the flowchart of FIG. 7.

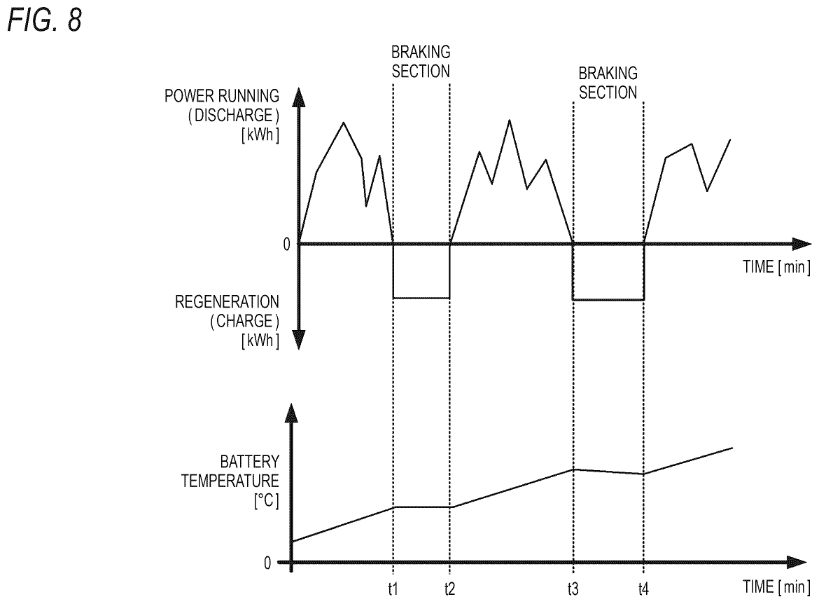

As described above, in the present embodiment, the current value under which the heat absorption amount Qs of the battery 4 is equal to or greater than the heat generation amount Qr during regeneration is calculated based on the resistance value R of the battery 4 and the reaction heat S per unit current value generated by the electrochemical reaction of the battery 4, and the first motor-generator 2 is controlled based on the calculated current value. That is, by calculating the current value under which the heat absorption amount Qs is equal to or greater than the heat generation amount Qr, it is possible to calculate the current value in a range in which the temperature of the battery 4 does not increase due to energization during regeneration. Accordingly, for example, as illustrated in FIG. 8, in braking sections from a time point t1 to a time point t2 and from a time point t3 to a time point t4, at least the battery temperature 4 does not increase, and therefore, for example, the regeneration amount of the electric power can be increased as compared with a case where the regeneration is performed without considering the endothermic reaction occurring during the regeneration. That is, it is possible to increase the regeneration amount while preventing the increase in the battery temperature, which contributes to an improvement in energy efficiency.

Since the regeneration amount can be increased in this way, the electric power stored in the battery 4 increases, so that a decrease in the SOC can be prevented, and as a result, a high voltage can be maintained. Since the high voltage can be maintained, the current value during discharge can be reduced, and therefore, heat generation of the battery 4 due to the discharge can be reduced.

In the present embodiment, the reaction heat S per unit current value is derived based on the SOC of the battery 4 or based on the SOC and the battery temperature. The SOC and the battery temperature of the battery 4 can be derived based on the detection value of the battery sensor, that is, the reaction heat S per unit current value can be derived by such a simple configuration, and the regeneration amount can be increased using the reaction heat S as one parameter.

As illustrated in the map of FIG. 5, the reaction heat S per unit current value gradually decreases from “S1” to “S2” as the SOC increases (in the example of FIG. 5, increases between “δ[%] to ε[%]”). The current value during regeneration affects a brake feeling since the reaction heat S per unit current value is used as one parameter. That is, when the regenerative braking force is generated, if the regenerative current is rapidly reduced, so-called torque loss in which a regenerative torque decreases according to the regenerative current may occur, and the brake feeling may deteriorate, but in the present embodiment, the reaction heat S per unit current value gradually decreases, so that it is possible to prevent the deterioration of the brake feeling due to the torque loss.

In the present embodiment, the resistance value R of the battery 4 is derived based on the SOC of the battery 4 or based on the SOC and the battery temperature, similarly to the reaction heat S per unit current value. With such a simple configuration, the resistance value R of the battery 4 can be derived, and the regeneration amount can be increased using the resistance value R as one parameter.

In the present embodiment, when the temperature of the battery is equal to or higher than the predetermined temperature near the upper limit temperature, the current value under which the heat absorption amount of the battery 4 is equal to or higher than the heat generation amount during regeneration is multiplied by the temperature increase prevention coefficient K, which is a predetermined correction coefficient. Accordingly, for example, even when the battery temperature is near the upper limit temperature, it is possible to maximize the regeneration amount while preventing an increase in the battery temperature. When the battery temperature is near the upper limit temperature (for example, 30[° C.] to 35[° C.]), since the regeneration limitation is not applied as compared with the case where the battery temperature is, for example, “5[° C.]”, the regeneration amount can be further increased by maximizing the regeneration amount in this way.

In the present embodiment, the brake device 12 performs braking by generating a remaining braking force with respect to the required braking force left by the braking performed by the first motor-generator 2. Accordingly, it is possible to cause the brake device 12 to generate a braking force insufficient for the required braking force excluding the regenerative braking force while increasing the regeneration amount to the maximum, and it is possible to prevent deterioration of members such as wear of each member constituting the brake device 12.

In the present embodiment, the brake device 12 is implemented by a brake-by-wire system. That is, since the braking force can be electronically controlled in a state where a mechanical connection between the brake pedal and the brake device 12 is cut off, for example, when the driver operates the brake pedal, a reaction speed for generating the braking force is increased, and as a result, the brake feeling can be improved.

### Modification

Next, a modification will be described. In the above-described embodiment, the control device 20 is configured to derive the resistance value R based on the map of FIG. 4 by the function of the resistance value derivation unit 21, but instead of this configuration, for example, the control device 20 may acquire a voltage change amount ΔV per unit time and a current change amount ΔI per unit time of the battery 4 based on the detection values of the battery sensor, and divide the acquired voltage change amount ΔV by the current change amount ΔI to derive the resistance value R (R=ΔV/ΔI) of the battery 4.

In the above-described embodiment, the temperature increase prevention coefficient K is set to “1” or “K1” depending on whether the battery temperature is equal to or higher than the predetermined temperature as described with reference to FIG. 6, but the temperature increase prevention coefficient K may be, for example, a value that gradually decreases as the battery temperature increases or a value that decreases stepwise as the battery temperature increases.

### (Others)

Although an embodiment of the present disclosure has been described above with reference to the drawings, it goes without saying that the present disclosure is not limited to the embodiment described above. It is apparent that those skilled in the art may conceive of various modifications and changes within the scope described in the claims, and it is understood that such modifications and changes naturally fall within the technical scope of the present disclosure.

The control method described in the above embodiments can be implemented by executing a prepared control program on a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

In the present specification, at least the following matters are described. Although corresponding constituent elements in the embodiment described above are shown in parentheses, the present disclosure is not limited thereto.
(1) A control device (control device 20) that controls a vehicle (vehicle Ve) including a drive wheel (drive wheel 5), a motor-generator (first motor-generator 2) that performs regeneration by braking the drive wheel and a battery (battery 4) supplied with regenerative electric power generated by the regeneration, the control device including:
a calculation unit (calculation unit 24) that calculates a current value under which a heat absorption amount of the battery is equal to or greater than a heat generation amount during the regeneration, based on a resistance value (resistance value R) of the battery and a reaction heat (reaction heat S) per unit current value generated by an electrochemical reaction of the battery; and
a control unit (control unit 26) that controls the motor-generator based on the calculated current value.

According to (1), since the battery temperature decreases (or does not increase at least, the regeneration amount of the electric power can be increased as compared with, for example, the case where the regeneration of the electric power is performed without considering the endothermic reaction occurring during the regeneration. That is, it is possible to increase the regeneration amount while preventing an increase in the battery temperature.
(2) The control device according to (1), further including:
a reaction heat derivation unit (reaction heat derivation unit 22) that derives the reaction heat, in which
the reaction heat derivation unit derives the reaction heat per unit current value based on a remaining charge amount of the battery.

According to (2), the reaction heat per unit current value can be derived with a simple configuration based on the remaining charge amount of the battery, and the regeneration amount can be increased using the reaction heat as one parameter.
(3) The control device according to (2), in which
the reaction heat derivation unit derives the reaction heat per unit current value further based on a temperature of the battery.

According to (3), the reaction heat per unit current value can be derived with a simple configuration based on the remaining charge amount of the battery and the battery temperature, and the regeneration amount can be increased using the reaction heat as one parameter.
(4) The control device according to (1), further including:
a resistance value derivation unit (resistance value derivation unit 21) that derives the resistance value of the battery, in which
the resistance value derivation unit derives the resistance value of the battery based on a current remaining charge amount of the battery with reference to a map in which a remaining charge amount of the battery and a resistance value under the remaining charge amount are associated with each other.

According to (4), the resistance value of the battery can be derived with a simple configuration based on the remaining charge amount of the battery, and the regeneration amount can be increased using the resistance value as one parameter.
(5) The control device according to (4), in which
the resistance value derivation unit derives the resistance value of the battery further based on a temperature of the battery.

According to (5), the resistance value of the battery can be derived with a simple configuration based on the remaining charge amount of the battery and the battery temperature, and the regeneration amount can be increased using the resistance value as one parameter.
(6) The control device according to (1), in which
in response to a current temperature of the battery being equal to or higher than a predetermined temperature near an upper limit temperature, the calculation unit multiplies, by a predetermined correction coefficient (temperature increase prevention coefficient K), the current value under which the heat absorption amount of the battery is equal to or greater than the heat generation amount during the regeneration, and
the control unit controls the motor-generator based on the current value multiplied by the predetermined correction coefficient.

According to (6), for example, even when the battery temperature is near the upper limit temperature, it is possible to maximize the regeneration amount while preventing an increase in the battery temperature.
(7) The control device according to (1), in which
the vehicle further includes a brake device that brakes the drive wheel, and
the control unit is further configured to control the brake device, and causes the brake device to generate a remainder of a required braking force excluding the regeneration of the motor-generator.

According to (7), it is possible to cause the brake device to generate a braking force insufficient for the required braking force excluding the regenerative braking force while increasing the regeneration amount to the maximum, and it is possible to prevent deterioration of members such as wear of each member constituting the brake device.
(8) The control device according to (7), in which
the brake device includes a brake-by-wire system.

According to (8), since the braking force can be electronically controlled in a state where a mechanical connection between the brake pedal and the brake device is cut off, for example, when the driver operates the brake pedal, a reaction speed for generating the braking force is increased, and as a result, the brake feeling can be improved.
(9) The control device according to (1), further including:
a resistance value derivation unit that derives the resistance value of the battery, in which
the resistance value derivation unit derives the resistance value of the battery based on a voltage change amount and a current change amount of the battery.

According to (9), the resistance value of the battery can be derived with a simple configuration based on the voltage and the change amount in current of the battery, and the regeneration amount can be increased using the resistance value as one parameter.
(10) A control method performed by a computer that controls a vehicle (vehicle Ve) including a drive wheel (drive wheel 5), a motor-generator (first motor-generator 2) that performs regeneration by braking the drive wheel and a battery (battery 4) supplied with regenerative electric power generated by the regeneration, the control method including:
calculating a current value (current value I) under which a heat absorption amount of the battery is equal to or greater than a heat generation amount during the regeneration, based on a resistance value (resistance value R) of the battery and a reaction heat (reaction heat S) per unit current value generated by an electrochemical reaction of the battery, and
controlling the motor-generator based on the calculated current value.

According to (10), since the battery temperature decreases (or does not increase at least, the regeneration amount of the electric power can be increased as compared with, for example, the case where the regeneration of the electric power is performed without considering the endothermic reaction occurring during the regeneration. That is, it is possible to increase the regeneration amount while preventing an increase in the temperature of the battery.

What is claimed is:

1. A control device that controls a vehicle including a drive wheel, a motor-generator that performs regeneration by braking the drive wheel and a battery supplied with regenerative electric power generated by the regeneration, the control device comprising:
a calculation unit that calculates a current value under which a heat absorption amount of the battery is equal to or greater than a heat generation amount during the regeneration, based on a resistance value of the battery and a reaction heat per unit current value generated by an electrochemical reaction of the battery; and
a control unit that controls the motor-generator based on the calculated current value.

2. The control device according to claim 1, further comprising:
a reaction heat derivation unit that derives the reaction heat, wherein
the reaction heat derivation unit derives the reaction heat per unit current value based on a remaining charge amount of the battery.

3. The control device according to claim 2, wherein
the reaction heat derivation unit derives the reaction heat per unit current value further based on a temperature of the battery.

4. The control device according to claim 1, further comprising:
a resistance value derivation unit that derives the resistance value of the battery, wherein
the resistance value derivation unit derives the resistance value of the battery based on a current remaining charge amount of the battery with reference to a map in which a remaining charge amount of the battery and a resistance value under the remaining charge amount are associated with each other.

5. The control device according to claim 4, wherein
the resistance value derivation unit derives the resistance value of the battery further based on a temperature of the battery.

6. The control device according to claim 1, wherein
in response to a current temperature of the battery being equal to or higher than a predetermined temperature near an upper limit temperature, the calculation unit multiplies, by a predetermined correction coefficient, the current value under which the heat absorption amount of the battery is equal to or greater than the heat generation amount during the regeneration, and
the control unit controls the motor-generator based on the current value multiplied by the predetermined correction coefficient.

7. The control device according to claim 1, wherein
the vehicle further includes a brake device that brakes the drive wheel, and
the control unit is further configured to control the brake device, and causes the brake device to generate a remainder of a required braking force excluding the regeneration of the motor-generator.

8. The control device according to claim 7, wherein
the brake device includes a brake-by-wire system.

9. The control device according to claim 1, further comprising:
a resistance value derivation unit that derives the resistance value of the battery, wherein
the resistance value derivation unit derives the resistance value of the battery based on a voltage change amount and a current change amount of the battery.

10. A control method performed by a computer that controls a vehicle including a drive wheel, a motor-generator that performs regeneration by braking the drive wheel and a battery supplied with regenerative electric power generated by the regeneration, the control method comprising:
calculating a current value under which a heat absorption amount of the battery is equal to or greater than a heat generation amount during the regeneration, based on a resistance value of the battery and a reaction heat per unit current value generated by an electrochemical reaction of the battery, and
controlling the motor-generator based on the calculated current value.
